(19) United States
(12) Patent Application Publication
(10) Pub. No.: US 2025/0004482 A1
(43) Pub. Date: Jan. 2, 2025

(54) METHOD, APPARATUS AND DEVICE FOR DETECTING AND POSITIONING INSPECTION TARGET AND STORAGE MEDIUM

(71) Applicant: AUTEL ROBOTICS CO., LTD., Nanshan Dist (CN)

(72) Inventors: Yaxue LI, Shenzhen (CN); Kangli WANG, Shenzhen (CN); Jia XU, Shenzhen (CN)

(21) Appl. No.: 18/761,163

(22) Filed: Jul. 1, 2024

(30) Foreign Application Priority Data
Jun. 30, 2023 (CN) 202310801652.4

(51) Int. Cl. G05D 1/689; G05D 105/80; G06T 7/73; G06V 20/17

(52) U.S. Cl. CPC G05D 1/689; G06T 7/73; G06V 20/17; G05D 2105/87; G06T 2207/10032; G06V 2201/07

(57) ABSTRACT

The present disclosure provides a method, apparatus and device for detecting and positioning an inspection target and a storage medium. The method includes: detecting a first inspection target and a first geographical position of the first inspection target in a target inspection sub-area of an inspection device, the target inspection sub-area being a sub-area inspected by the inspection device during a process of performing an inspection task; and displaying the first inspection target at the first geographical position in an inspection map. In this technical solution, there is no need for a user to monitor an inspection screen in real time.

### CROSS REFERENCE TO RELATED DISCLOSURE

This application claims the benefit of and priority to Chinese patent application 202310801652.4, filed Jun. 30, 2023 and titled “METHOD, APPARATUS AND DEVICE FOR DETECTING AND POSITIONING INSPECTION TARGET AND STORAGE MEDIUM,” the entirety of which is hereby incorporated herein by reference.

### BACKGROUND

With the development of science and technology, more and more industries choose to implement inspection by means of an unmanned aerial vehicle instead of traditional manual inspection. The unmanned aerial vehicle may be equipped with a variety of tools, such as a camera and an infrared sensor.

After a flight task is set for the unmanned aerial vehicle, the unmanned aerial vehicle may transmit, during the process of performing the task, images and videos collected thereby to a background system in real time, and a background worker monitors an inspection screen in real time to determine a target in the screen. This is not convenient enough.

### SUMMARY

The present disclosure relates to the field of target detection, and in particular, to a method, apparatus and device for detecting and positioning an inspection target and a storage medium.

The present disclosure provides a method, apparatus and device for detecting and positioning an inspection target and a storage medium, so as to solve the technical problem that during inspection by means of an unmanned aerial vehicle, a background worker needs to monitor an inspection screen in real time to position a target.

In a first aspect, a method for detecting and positioning an inspection target is provided, including:
detecting a first inspection target and a first geographical position of the first inspection target in a target inspection sub-area of an inspection device, the target inspection sub-area being a sub-area inspected by the inspection device during a process of performing an inspection task; and
displaying the first inspection target at the first geographical position in an inspection map.

In a second aspect, an apparatus for detecting and positioning an inspection target is provided, including:
a target detection module, configured to detect a first inspection target and a first geographical position of the first inspection target in a target inspection sub-area of an inspection device, the target inspection sub-area being a sub-area inspected by the inspection device during a process of performing an inspection task; and
a target display module, configured to display the first inspection target at the first geographical position in an inspection map.

In a third aspect, a computer device is provided, including a memory and one or more processors, where the memory is connected to the one or more processors, the one or more processors being configured to execute one or more computer programs stored in the memory, and when the one or more processors execute the one or more computer programs, the computer device is enabled to implement the method for detecting and positioning an inspection target according to the first aspect described above.

In a fourth aspect, a computer-readable storage medium is provided, where the computer-readable storage medium stores a computer program, the computer program including program instructions, and when the program instructions are executed by a processor, the processor is enabled to perform the method for detecting and positioning an inspection target according to the first aspect described above.

### BRIEF DESCRIPTION OF THE DRAWINGS

FIG. 1 is a schematic diagram of an inspection system according to an embodiment of the present disclosure;

FIG. 2 is a schematic flowchart of a method for detecting and positioning an inspection target according to an embodiment of the present disclosure;

FIG. 3 is a schematic diagram showing displaying of an inspection target in an inspection map according to an embodiment of the present disclosure;

FIG. 4 is a schematic flowchart of another method for detecting and positioning an inspection target according to an embodiment of the present disclosure;

FIG. 5 is a schematic diagram of an inspection image and an inspection map area corresponding to the inspection image according to an embodiment of the present disclosure;

FIG. 6 is a schematic diagram showing display, in an inspection map, of inspection targets and positions of the inspection targets in an inspection target set according to an embodiment of the present disclosure;

FIG. 7 is a schematic structural diagram of an apparatus for detecting and positioning an inspection target according to an embodiment of the present disclosure; and

FIG. 8 is a schematic structural diagram of a computer device according to an embodiment of the present disclosure.

### DETAILED DESCRIPTION

Technical solutions in embodiments of the present disclosure are described below with reference to the accompanying drawings in the embodiments of the present disclosure.

The technical solutions of the present disclosure are suitable for an inspection scenario. The inspection scenario may refer to a scenario in which an unmanned aerial vehicle flies to perform an inspection task, or a scenario in which another inspection device is used to perform an inspection task, such as a scenario in which an inspection robot walks on the ground to perform an inspection task on the ground.

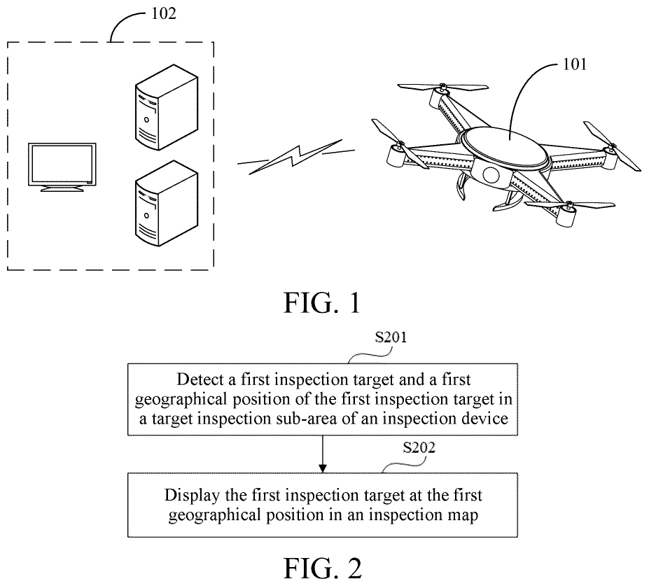

The technical solutions of the present disclosure can be applied to an inspection device for performing an inspection task, and can be also applied to an inspection control platform in an inspection system including an inspection device. First, referring to FIG. 1, FIG. 1 is a schematic diagram of an inspection system according to an embodiment of the present disclosure. As shown in FIG. 1, the inspection system 10 may include an inspection device 101 and an inspection control platform 102. The inspection device 101 is configured to travel in an area that needs to be inspected (that is, an inspection area) instead of a person, collect relevant data (image data and various sensor data) in the inspection area in real time, and transmit the collected relevant data to the inspection control platform 102 to complete an inspection task. The inspection control platform 102 is a user-oriented device, and the inspection control platform 102 is configured to deliver an inspection instruction to the inspection device 101 to instruct the inspection device 101 to perform an inspection task based on the inspection instruction. An area covered by the inspection device to perform the inspection task is the inspection area. The inspection control platform 102 may send an inspection instruction to the inspection device 101 in response to a user instruction, so that the inspection device 101 performs an inspection task under the control of a user.

Specifically, the inspection device 101 may be an unmanned aerial vehicle or an inspection robot, or the like. The inspection control platform 102 may include a cloud platform, a background server, a human-computer interaction device (such as a display), and the like.

Based on the inspection system shown in FIG. 1, the technical solutions of the present disclosure can be implemented. The technical solutions of the present disclosure are specifically described below.

Referring to FIG. 2, FIG. 2 is a schematic flowchart of a method for detecting and positioning an inspection target according to an embodiment of the present disclosure. As shown in FIG. 2, the method includes the following steps.

S201: Detect a first inspection target and a first geographical position of the first inspection target in a target inspection sub-area of an inspection device.

Herein, the target inspection sub-area is a sub-area detected by the inspection device during a process of performing an inspection task. The process of performing an inspection task by the inspection device may be specifically a road inspection process, an electric power inspection process, a safety inspection process, and the like, and is not limited to the examples herein. The target inspection sub-area may be understood as an area within a maximum range that can be detected by a sensor on the inspection device when the inspection device performs a task. The target inspection sub-area is a part of an inspection area of the inspection device. The inspection area of the inspection device refers to an area that needs to be covered during the process of performing an inspection task by the inspection device. The inspection area of the inspection device is related to an inspection task performed by the inspection device. If an inspection task performed by the inspection device is different, an inspection area of the inspection device is different. For example, if an inspection task performed by the inspection device is to inspect a whole campus area, the inspection area of the inspection device is the whole campus area, and the target inspection sub-area may be a classroom area, a playground area, an office area, and the like in the campus. Both the target inspection sub-area and the inspection area may be denoted in an inspection map, and the inspection map is a map adopted during the process of performing an inspection task by the inspection device.

The inspection target refers to a target that the inspection device needs to acquire/detect when performing an inspection task. If an inspection task performed by the inspection device is different, an inspection target is different. For example, if an inspection task performed by the inspection device is a road inspection task, an inspection target may be a pedestrian, a vehicle, a traffic light sign, and the like on a road. For another example, if an inspection task performed by the inspection device is an electric power inspection process, an inspection target may be a telegraph pole. This is not restricted in the present disclosure.

The first inspection target in the target inspection sub-area refers to an inspection target located in the target inspection sub-area when the inspection device performs a task. The first geographical position of the first inspection target refers to a geographical position of the first inspection target in the inspection map, and the first geographical position is denoted by coordinates in a world coordinate system.

In some possible cases, the first inspection target and the first geographical position of the first inspection target may be detected based on image identification and target positioning.

The first inspection target and the first geographical position of the first inspection target may be detected by steps A1 and A2 below.

A1: Perform inspection target identification on the inspection image obtained by the inspection device to obtain the first inspection target and first image coordinates of the first inspection target in the inspection image obtained by the inspection device.

Herein, the inspection image obtained by the inspection device refers to an image obtained by the inspection device during the process of performing an inspection task. The inspection image obtained by the inspection device may be photographed by a camera in the inspection device.

In a possible implementation, inspection target identification may be performed, by means of a target identification model, on the inspection image obtained by the inspection device, to obtain the first inspection target and the first image coordinates of the first inspection target in the inspection image.

The target identification model may be a model trained based on a deep learning technology and used to identify an inspection target. The target identification model includes, but is not limited to, a region-based convolutional neural network (RCNN) model, a you only look once (YOLO) model and a single shot multibox detector (SSD) model, which is not restricted in the present disclosure.

After the inspection image obtained by the inspection device is input into the target identification model, the target identification model may output information {ut, vt, w, h, c} of an inspection target in the inspection image. The inspection target in the inspection image is the first inspection target. (ut, vt) is pixel coordinates of a central point of the first inspection target in the inspection image obtained by the inspection device, w and h are a width and a height of the first inspection target in the inspection image obtained by the inspection device respectively, and c is a category of the first inspection target. For example, if an inspection task performed by the inspection device is a road inspection task, the category of the first inspection target may be one of a pedestrian, a vehicle, a traffic light sign, and the like on a road.

It should be understood that (ut, vt) may be transformed into coordinates (xt, yt) in an image coordinate system, and the coordinates in the image coordinate system may be transformed from coordinates in a pixel coordinate system. The coordinates in the image coordinate system and the coordinates in the pixel coordinate system meet the following transformation relationship: x=(u−uo)*W, y=(v−vo)*H, where (x, y) denotes coordinates in the image coordinate system, (u, v) denotes coordinates in the pixel coordinate system, W and H are a width and a height of the inspection image respectively, and (uo, vo) is pixel coordinates of a center of the inspection image. The first image coordinates of the first inspection target in the inspection image obtained by the inspection device may be (ut, vt) or (xt, yt).

A2: Perform coordinate transformation on the first image coordinates of the first inspection target in the inspection image obtained by the inspection device to obtain first geographical position coordinates of the first inspection target.

The first geographical position coordinates are coordinates in a world coordinate system, and the coordinates in the world coordinate system may be global positioning system (GPS) coordinates. The coordinates in the world coordinate system may be denoted as (X, Y, Z), and the first geographical position coordinates are (Xt, Yt, Zt).

Herein, coordinate transformation may be performed, by steps A21-A23, on the first image coordinates of the first inspection target in the inspection image obtained by the inspection device.

A21: Obtain a first device posture and first device position coordinates of the inspection device.

The first device posture of the inspection device is a device posture when the inspection device obtains the inspection image, and the first device posture may be denoted by an Euler angle. The first device posture may be denoted as (γ, θ, φ), where γ is a heading angle, which refers to an angle of rotation relative to a z-axis of the world coordinate system, θ is a roll angle, which refers to an angle of rotation relative to an x-axis of the world coordinate system, and φ is a pitch angle, which refers to an angle of rotation relative to a y-axis of the world coordinate system.

The first device position coordinates of the inspection device are position coordinates when the inspection device obtains the inspection image, and the first device position coordinates are coordinates in the world coordinate system. The first device position coordinates may be denoted as (X0, Y0, Z0), and X0, Y0 and Z0 may denote translation parameters of the inspection device relative to an origin of the world coordinate system when the inspection device obtains the inspection image. In a world coordinate system with a WGS-84 coordinate system as a GPS coordinate system, the origin of the world coordinate system may be a center of mass of the earth.

A22: Determine a target transformation matrix based on the first device posture and the first device position coordinates of the inspection device.

The target transformation matrix is used to denote a transformation relationship between the pixel coordinate system and the world coordinate system when the inspection device obtains the inspection image. The target transformation matrix may include a first projection transformation matrix and a second projection transformation matrix. The first projection transformation matrix is used to denote a transformation relationship between a camera coordinate system and a device coordinate system, and the second projection transformation matrix is used to denote a transformation relationship between the device coordinate system and the world coordinate system. The first projection transformation matrix may be denoted as R1. Since the camera is fixed to the inspection device, a relative position relationship between the camera and the inspection device is fixed, and therefore the first transformation matrix may be obtained by pre-calibration. The second transformation matrix includes a rotation matrix R2 and a translation vector T. The rotation matrix R2 may be obtained based on the first device posture when the inspection device obtains the inspection image, and the translation vector T is obtained based on the first device position coordinates.

A23: Perform, based on the target transformation matrix, coordinate transformation on the first image coordinates of the first inspection target in the inspection image obtained by the inspection device to obtain the first geographical position coordinates.

Herein, coordinate transformation may be performed, based on the following transformation formulas (1) to (3), on the first image coordinates of the first inspection target in the inspection image obtained by the inspection device to obtain the first geographical position coordinates.

$$P 2 = ZK - 1 P 1 ; \qquad ( 1 )$$

$$P 3 = R 1 P 2 ; and \qquad ( 2 )$$

$$P 4 = R 2 P3 + T , \qquad ( 3 )$$

where K is a camera intrinsic matrix of the camera in the inspection device, P1 is coordinates in the pixel coordinate system, P1 herein may be aforementioned (ut, vt, 1), P2 is coordinates in the camera coordinate system, P3 is coordinates in the device coordinate system of the inspection device, and P4 is coordinates in the world coordinate system.

A geographical position of an inspection target is determined by means of target identification and coordinate transformation, so that the geographical position of the inspection target can be accurately determined.

S202: Display the first inspection target at the first geographical position in the inspection map.

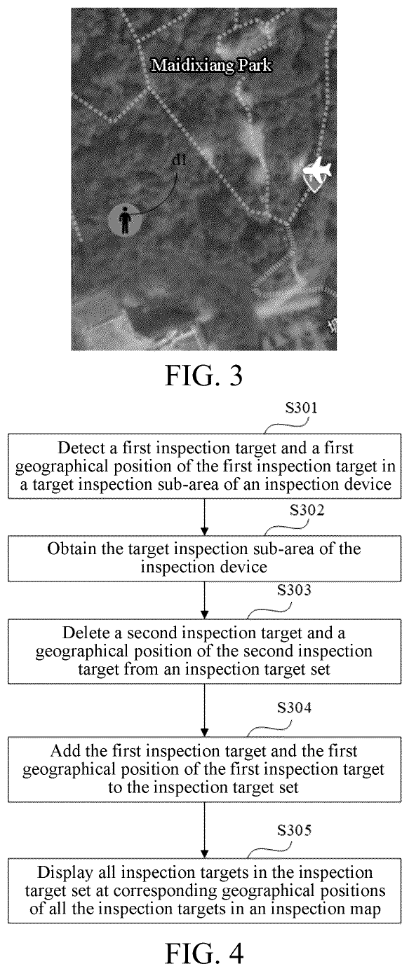

For example, displaying the first inspection target at the first geographical position in the inspection map may be as shown in FIG. 3, and dl in FIG. 3 is the detected first inspection target.

Optionally, the first geographical position coordinates of the first inspection target may be also displayed in the inspection map. For example, if the first geographical position coordinates are (Xt, Yt, Zt), the first geographical position coordinates (Xt, Yt, Zt) may be displayed at the first geographical position, so that the user can conveniently determine a specific geographical position of the inspection target.

In the technical solution corresponding to FIG. 2, the inspection target and the geographical position of the inspection target in the inspection sub-area of the inspection device are detected, and then the inspection target in the inspection sub-area is displayed at the corresponding geographical position in the inspection map, so that by viewing the inspection map, the user can quickly determine the inspection target and the geographical position of the inspection target that are inspected by the inspection device during the process of performing an inspection task, with no need for the user to monitor an inspection screen in real time, which is more simple and convenient.

Referring to FIG. 4, FIG. 4 is a schematic flowchart of another method for detecting and positioning an inspection target according to an embodiment of the present disclosure. As shown in FIG. 4, the method includes the following steps.

S301: Detect a first inspection target and a first geographical position of the first inspection target in a target inspection sub-area of an inspection device.

Herein, for the specific implementation method for step S301, refer to the description of step S201 above, and details are not described herein.

S302: Obtain the target inspection sub-area of the inspection device.

Herein, for the description of the target inspection sub-area, refer to the description of step S201 above, and details are not described herein.

In a feasible implementation, the target inspection sub-area of the inspection device may be obtained based on image identification. An inspection image obtained by the inspection device may be obtained; and an inspection map area corresponding to the inspection image obtained by the inspection device is determined as the target inspection sub-area.

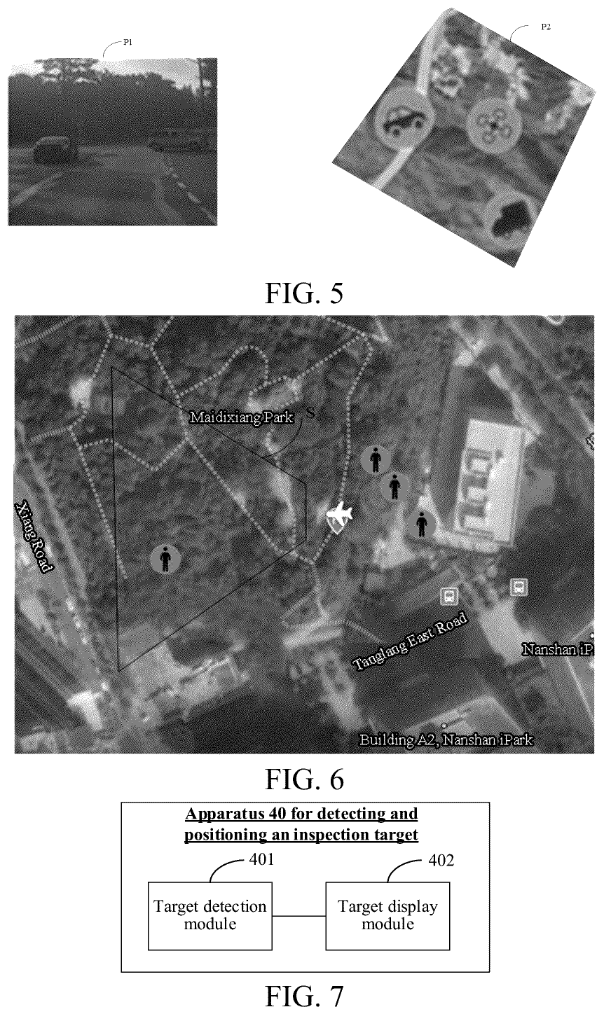

The inspection map area corresponding to the inspection image is an area formed by mapping image vertices of the inspection image to the inspection map. For example, referring to FIG. 5, it is assumed that an inspection image obtained by the inspection device is shown as P1 in FIG. 5, and an area formed by mapping image vertices of the inspection image to the inspection map is shown as P2 in FIG. 5. The image content in P2 is the inspection map.

The inspection map area corresponding to the inspection image may be determined by the following steps B1 to B3.

B1: Obtain vertex image coordinates of the inspection image obtained by the inspection device.

The vertex image coordinates may be coordinates in the pixel coordinate system or coordinates in the image coordinate system. When the vertex image coordinates are coordinates in the pixel coordinate system, the vertex image coordinates of the inspection image include (0, 0, 1), (0, H, 1), (W, 0, 1) and (W, H, 1), which denote coordinates of an upper left corner, a lower left corner, an upper right corner and a lower right corner of the inspection image in the pixel coordinate system, respectively.

B2: Perform coordinate transformation on the vertex image coordinates of the inspection image to obtain inspection position coordinates corresponding to the inspection image.

The inspection position coordinates are coordinates in the world coordinate system. The inspection position coordinates corresponding to the inspection image include (X1, Y1, Z1), (X2, Y2, Z2), (X3, Y3, Z3) and (X4, Y4, Z4), which denote coordinates of the upper left corner, the lower left corner, the upper right corner and the lower right corner of the inspection image in the world coordinate system, respectively.

Coordinate transformation may be performed on the vertex image coordinates of the inspection image by steps B21 to B23.

B21: Obtain a first device posture and first device position coordinates of the inspection device.

B22: Determine a target transformation matrix based on the first device posture and the first device position coordinates of the inspection device.

Herein, for the specific implementation method for steps B21 and B22, refer to the description of steps A21 and A22 above, and details are not described herein.

B23: Perform coordinate transformation on the vertex image coordinates of the inspection image based on the target transformation matrix to obtain inspection position coordinates corresponding to the inspection image.

Herein, coordinate transformation may be performed on the vertex image coordinates based on the transformation formulas (1) to (3) in aforementioned step A23, to obtain the inspection position coordinates corresponding to the inspection image obtained by the inspection device. P1 herein may be (0, 0, 1), (0, H, 1), (W, 0, 1) or (W, H, 1).

A3: Determine, in the inspection map, a sub-area formed by enclosing the inspection position coordinates corresponding to the inspection image as the inspection map area corresponding to the inspection image obtained by the inspection device.

Map points corresponding to four inspection position coordinates may be determined in the inspection map to obtain four map points, and the four map points may be connected in the inspection map to obtain the inspection map area corresponding to the inspection image obtained by the inspection device.

The inspection sub-area of the inspection device is determined by means of image acquisition and coordinate transformation, so that the inspection sub-area of the inspection device can be accurately determined.

Optionally, the target inspection sub-area of the inspection device may alternatively be obtained based on Lidar scanning, infrared scanning, or the like, which is not restricted in the present disclosure.

S303: Delete a second inspection target and a geographical position of the second inspection target from the inspection target set.

Herein, the inspection target set includes all inspection targets and geographical positions of all the inspection targets that have been detected by the inspection device during a process of performing an inspection task, and the geographical positions of all the inspection targets in the inspection target set are denoted by coordinates in the world coordinate system. In addition to including the inspection targets and the geographical positions of the inspection targets, the inspection target set may further include categories of the inspection targets. The inspection target set may include a plurality of inspection target subsets, and different inspection target subsets may include different categories of inspection targets.

The second inspection target is an inspection target in the inspection target set and located in the target inspection sub-area, and the effect of deleting the second inspection target and the geographical position of the second inspection target from the inspection target set is to ensure uniqueness of the inspection target in the inspection target set.

Optionally, before the second inspection target and the geographical position of the second inspection target are deleted from the inspection target set, whether the second inspection target exists in the inspection target set may be first determined. If the second inspection target exists in the inspection target set, inspection targets in the target inspection sub-area may have been detected before, and the first inspection target may already exist in the inspection target set. As a result, direct addition may cause the inspection targets in the inspection target set to be duplicated, and step S303 needs to be performed. If no second inspection target exists in the inspection target set, no inspection target in the target inspection sub-area has been detected before, and step S303 may be skipped and step S304 may be directly performed.

In a feasible implementation, whether the second inspection target exists in the inspection target set may be determined by the following steps C1 to C3.

C1: Determine whether a second geographical position in the target inspection sub-area exists in the inspection target set.

Specifically, each geographical position in the inspection target set may be compared with the geographical position contained in the target inspection sub-area, to determine whether each geographical position in the inspection target set is within the target inspection sub-area. If any geographical position in the inspection target set is within the target inspection sub-area, the second geographical position in the target inspection sub-area exists in the inspection target set. If each geographical position in the inspection target set is not within the target inspection sub-area, no second geographical position in the target inspection sub-area exists in the inspection target set, and step 304 may be directly performed.

C2: Determine, if the second geographical position exists in the inspection target set, that the second inspection target exists in the inspection target set.

When the second inspection target exists in the inspection target set, it can be also determined whether the geographical position of the second inspection target is the same as the first geographical position. If the geographical position of the second inspection target is the same as the first geographical position, no change occurs in the inspection target and the geographical position of the inspection target in the target inspection sub-area, and therefore steps S303 and step S304 may be skipped and step S305 may be directly performed. If the geographical position of the second inspection target is different from the first geographical position, a change occurs in the inspection target and/or the geographical position of the inspection target in the target inspection sub-area, and S303 is performed.

C3: Determine, if no second geographical position exists in the inspection target set, that no second inspection target exists in the inspection target set.

Whether an inspection target exists in the inspection target set is detected by detecting whether a target position in the target inspection sub-area exists in the inspection target set, and the implementation method is simple.

Optionally, whether the second inspection target exists in the inspection target set may alternatively be determined by other implementation methods.

S304: Add the first inspection target and the first geographical position of the first inspection target to the inspection target set.

S305: Display all inspection targets in the inspection target set at corresponding geographical positions of all the inspection targets in the inspection map.

Herein, displaying all the inspection targets in the inspection target set at corresponding geographical positions of all the inspection targets in the inspection map may be as shown in FIG. 6. An area S in FIG. 6 is the target inspection sub-area, and an inspection target and a geographical position in the area S are the first inspection target and the first geographical position. Inspection targets and geographical positions outside the area S are inspection targets and positions that have been detected by the inspection device during a process of performing an inspection task.

In the technical solution corresponding to FIG. 4, after the target inspection sub-area of the inspection device is obtained and a geographical position of an inspection target in the target inspection sub-area is detected, the inspection target in the target inspection sub-area and the geographical position of the inspection target in the target inspection sub-area are first deleted from the inspection target set, and then the inspection target and the geographical position of the inspection target that are detected are added to the inspection target set. This can implement deduplication of the same inspection targets in the inspection target set and ensure accurate statistics of inspection targets. Finally, all the inspection targets in the inspection target set are displayed at the corresponding geographical positions in the inspection map, so that based in the inspection map, the user can determine all the inspection targets and the positions of all the inspection targets during the whole inspection process, thereby completing global target statistics.

Further, the global target statistics include all inspection targets in the inspection area in this inspection task, such as statistics on types of the inspection targets in this area, statistics on fixed obstacles such as buildings, trees, telegraph poles and control towers in this inspection area, or moving targets such as vehicles and pedestrians. The user may select object types to be displayed in the inspection map by filtering the types of the inspection targets, or may perform statistics on motion states and motion trails of moving targets by filtering specific inspection targets.

The method according to the present disclosure is described above. An apparatus according to the present disclosure is described below.

In this technical solution, an inspection target and a geographical position of the inspection target in the inspection sub-area of the inspection device are detected, and then the inspection target in the inspection sub-area is displayed at a corresponding geographical position in the inspection map, so that by viewing the inspection map, a user can quickly determine the inspection target and the geographical position of the inspection target that are inspected by the inspection device during the process of performing an inspection task, with no need for the user to monitor an inspection screen in real time, which is more simple and convenient.

With reference to the first aspect, in a possible implementation, the displaying the first inspection target at the first geographical position in an inspection map includes: adding the first inspection target and the first geographical position to an inspection target set, the inspection target set including all inspection targets and geographical positions of all the inspection targets that have been detected by the inspection device during the process of performing an inspection task; and displaying all the inspection targets in the inspection target set at corresponding geographical positions of all the inspection targets in the inspection map. An inspection target and a geographical position of the inspection target are added to the inspection target set including all the inspection targets and the geographical positions of all the inspection targets that have been detected by the inspection device, and all the inspection targets in the inspection target set are displayed at the corresponding geographical positions in the inspection map, so that based in the inspection map, the user can determine all the inspection targets and the positions of all the inspection targets during the whole inspection process, thereby completing global target statistics.

With reference to the first aspect, in a possible implementation, before the adding the first inspection target and the first geographical position to an inspection target set, the method further includes: obtaining the target inspection sub-area; and
deleting a second inspection target and a geographical position of the second inspection target from the inspection target set, the second inspection target being an inspection target in the inspection target set and located in the target inspection sub-area. Before the detected inspection targets and the positions of the inspection targets are added to the inspection target set, the inspection target and the position thereof that are located in the inspection sub-area are first deleted from the inspection target set. This can implement deduplication of the same inspection targets in the inspection sub-area and ensure accurate statistics of targets.

With reference to the first aspect, in a possible implementation, before the deleting a second inspection target and a geographical position of the second inspection target from the inspection target set, the method further includes: determining whether a second geographical position in the target inspection sub-area exists in the inspection target set; and determining, if the second geographical position exists in the inspection target set, that the second inspection target exists in the inspection target set; or determining, if no second geographical position exists in the inspection target set, that no second inspection target exists in the inspection target set. Whether an inspection target in the inspection sub-area exists in the inspection target set is detected by detecting whether a geographical position in the inspection sub-area exists in the inspection target set, and the implementation method is simple.

With reference to the first aspect, in a possible implementation, the obtaining the target inspection sub-area includes: obtaining an inspection image obtained by the inspection device; and determining an inspection map area corresponding to the inspection image as the target inspection sub-area.

With reference to the first aspect, in a possible implementation, before the determining an inspection map area corresponding to the inspection image as the target inspection sub-area, the method includes: obtaining vertex image coordinates of the inspection image, the vertex image coordinates being coordinates in a pixel coordinate system; performing coordinate transformation on the vertex image coordinates to obtain inspection position coordinates corresponding to the inspection image, the inspection position coordinates being coordinates in a world coordinate system; and determining, in the inspection map, a sub-area formed by enclosing the inspection position coordinates as the inspection map area corresponding to the inspection image. The inspection sub-area of the inspection device is determined by means of image acquisition and coordinate transformation, so that the inspection sub-area of the inspection device can be accurately determined.

With reference to the first aspect, in a possible implementation, the detecting a first inspection target and a first geographical position of the first inspection target in a target inspection sub-area of an inspection device includes: performing inspection target identification on the inspection image obtained by the inspection device to obtain the first inspection target and first image coordinates of the first inspection target in the inspection image; and performing coordinate transformation on the first image coordinates to obtain first geographical position coordinates of the first inspection target, the first geographical position coordinates being coordinates in a world coordinate system. A geographical position of an inspection target is determined by means of target identification and coordinate transformation, so that the geographical position of the inspection target can be accurately determined.

With reference to the first aspect, in a possible implementation, the performing inspection target identification on the inspection image obtained by the inspection device to obtain the first inspection target and first image coordinates of the first inspection target in the inspection image includes: performing, by means of a target identification model, inspection target identification on the inspection image obtained by the inspection device to obtain the first inspection target and the first image coordinates of the first inspection target in the inspection image.

With reference to the first aspect, in a possible implementation, the performing coordinate transformation on the first image coordinates to obtain first geographical position coordinates of the first inspection target includes: obtaining a first device posture and first device position coordinates of the inspection device, the first device posture being a device posture when the inspection device obtains the inspection image, the first device position coordinates being geographical position coordinates when the inspection device obtains the inspection image, and the first device position coordinates being coordinates in the world coordinate system; determining a target transformation matrix based on the first device posture and the first device position coordinates, the target transformation matrix being used to denote a transformation relationship between a pixel coordinate system and the world coordinate system when the inspection device obtains the inspection image; and performing, based on the target transformation matrix, coordinate transformation on the first image coordinates to obtain the first geographical position coordinates.

Referring to FIG. 7, FIG. 7 is a schematic structural diagram of an apparatus for detecting and positioning an inspection target according to an embodiment of the present disclosure. As shown in FIG. 7, the apparatus 40 for detecting and positioning an inspection target includes:
a target detection module 401, configured to detect a first inspection target and a first geographical position of the first inspection target in a target inspection sub-area of an inspection device, the target inspection sub-area being a sub-area inspected by the inspection device during a process of performing an inspection task; and
a target display module 402, configured to display the first inspection target at the first geographical position in an inspection map.

In a possible design, the target display module 402 is further configured to: add the first inspection target and the first geographical position to an inspection target set, the inspection target set including all inspection targets and geographical positions of all the inspection targets that have been detected by the inspection device during the process of performing an inspection task; and display all the inspection targets in the inspection target set at corresponding geographical positions of all the inspection targets in the inspection map.

In a possible design, the target display module 402 is further configured to: obtain the target inspection sub-area; and delete a second inspection target and a geographical position of the second inspection target from the inspection target set, the second inspection target being an inspection target in the inspection target set and located in the target inspection sub-area.

In a possible design, the target display module 402 is further configured to: determine whether a second geographical position in the target inspection sub-area exists in the inspection target set; and determine, if the second geographical position exists in the inspection target set, that the second inspection target exists in the inspection target set; or determine, if no second geographical position exists in the inspection target set, that no second inspection target exists in the inspection target set.

In a possible design, the target display module 402 is further configured to: obtain an inspection image obtained by the inspection device; and determine an inspection map area corresponding to the inspection image as the target inspection sub-area.

In a possible design, the target display module 402 is further configured to: obtain vertex image coordinates of the inspection image, the vertex image coordinates being coordinates in a pixel coordinate system; perform coordinate transformation on the vertex image coordinates to obtain inspection position coordinates corresponding to the inspection image, the inspection position coordinates being coordinates in a world coordinate system; and determine, in the inspection map, a sub-area formed by enclosing the inspection position coordinates as the inspection map area corresponding to the inspection image.

In a possible design, the target detection module 401 is further configured to: perform inspection target identification on the inspection image obtained by the inspection device to obtain the first inspection target and first image coordinates of the first inspection target in the inspection image; and perform coordinate transformation on the first image coordinates to obtain first geographical position coordinates of the first inspection target, the first geographical position coordinates being coordinates in a world coordinate system.

In a possible design, the target detection module 401 is further configured to: perform, by means of a target identification model, inspection target identification on the inspection image obtained by the inspection device to obtain the first inspection target and the first image coordinates of the first inspection target in the inspection image.

In a possible design, the target detection module 401 is further configured to: obtain a first device posture and first device position coordinates of the inspection device, the first device posture being a device posture when the inspection device obtains the inspection image, the first device position coordinates being geographical position coordinates when the inspection device obtains the inspection image, and the first device position coordinates being coordinates in the world coordinate system; determine a target transformation matrix based on the first device posture and the first device position coordinates, the target transformation matrix being used to denote a transformation relationship between a pixel coordinate system and the world coordinate system when the inspection device obtains the inspection image; and perform, based on the target transformation matrix, coordinate transformation on the first image coordinates to obtain the first geographical position coordinates.

It should be noted that, for the content not mentioned in the embodiment corresponding to FIG. 7, refer to the description of the aforementioned method embodiment. Details are not described herein.

In the above apparatus, an inspection target and a geographical position of the inspection target in the inspection sub-area of the inspection device are detected, and then the inspection target in the inspection sub-area is displayed at a corresponding geographical position in the inspection map, so that by viewing the inspection map, a user can quickly determine the inspection target and the geographical position of the inspection target that are inspected by the inspection device during the process of performing an inspection task, with no need for the user to monitor an inspection screen in real time, which is more simple and convenient.

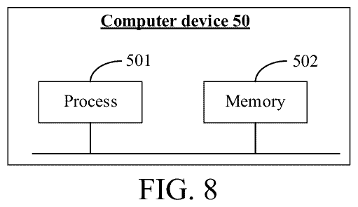

Referring to FIG. 8, FIG. 8 is a schematic structural diagram of a computer device according to an embodiment of the present disclosure. The computer device 50 includes a processor 501 and a memory 502. The memory 502 is connected to the processor 501, for example, by a bus.

The processor 501 is configured to support the computer device 50 to perform corresponding functions in the methods of the foregoing method embodiments. The processor 501 may be a central processing unit (CPU), a network processor (NP), a hardware chip or any combination thereof. The foregoing hardware chip may be an application specific integrated circuit (ASIC), a programmable logic device (PLD) or a combination thereof. The foregoing PLD may be a complex programmable logic device (CPLD), a field-programmable gate array (FPGA), generic array logic (GAL) or any combination thereof.

The memory 502 is configured to store program code and the like. The memory 502 may include a volatile memory (VM), such as a random access memory (RAM); or the memory 502 may include a non-volatile memory (NVM), such as a read-only memory (ROM), a flash memory, a hard disk drive (HDD) or a solid-state drive (SSD); or the memory 502 may include a combination of the foregoing types of memories.

The processor 501 may invoke the program code to perform the following operations:
detecting a first inspection target and a first geographical position of the first inspection target in a target inspection sub-area of an inspection device, the target inspection sub-area being a sub-area inspected by the inspection device during a process of performing an inspection task; and
displaying the first inspection target at the first geographical position in an inspection map.

The present disclosure can achieve the following technical effects: By viewing the inspection map, the user can quickly determine the inspection target and the geographical position of the inspection target that are inspected by the inspection device during the process of performing an inspection task, with no need for the user to monitor an inspection screen in real time, which is more simple and convenient.

An embodiment of the present disclosure further provides a computer-readable storage medium, where the computer-readable storage medium stores a computer program, the computer program including program instructions, and when the program instructions are executed by a computer, the computer is enabled to perform the method according to the foregoing embodiment.

A person of ordinary skill in the art may understand that all or some processes in implementing the method of the foregoing embodiment may be completed by using a computer program to instruct related hardware. The program may be stored in a computer-readable storage medium. The program, when executed, may include processes of the embodiment of each of the methods described above. The storage medium may be a magnetic disk, an optical disk, a read-only memory (ROM), a random access memory (RAM), or the like.

The above disclosed is only preferred embodiments of the present disclosure and, certainly, cannot be used to limit the scope of the claims of the present disclosure. Therefore, equivalent changes made according to the claims of the present disclosure shall still fall within the scope of the present disclosure.

What is claimed is:

1. A method for detecting and positioning an inspection target, comprising:
detecting a first inspection target and a first geographical position of the first inspection target in a target inspection sub-area of an inspection device, the target inspection sub-area being a sub-area inspected by the inspection device during a process of performing an inspection task; and
displaying the first inspection target at the first geographical position in an inspection map.

2. The method for detecting and positioning an inspection target according to claim 1, wherein the displaying the first inspection target at the first geographical position in an inspection map comprises:
adding the first inspection target and the first geographical position to an inspection target set, the inspection target set comprising all inspection targets and geographical positions of all the inspection targets that have been detected by the inspection device during the process of performing an inspection task; and
displaying all the inspection targets in the inspection target set at corresponding geographical positions of all the inspection targets in the inspection map.

3. The method for detecting and positioning an inspection target according to claim 2, wherein before the adding the first inspection target and the first geographical position to an inspection target set, the method further comprises:
obtaining the target inspection sub-area; and
deleting a second inspection target and a geographical position of the second inspection target from the inspection target set, the second inspection target being an inspection target in the inspection target set and located in the target inspection sub-area.

4. The method for detecting and positioning an inspection target according to claim 3, wherein before the deleting a second inspection target and a geographical position of the second inspection target from the inspection target set, the method further comprises:
determining whether a second geographical position in the target inspection sub-area exists in the inspection target set; and
determining, in response to the second geographical position exists in the inspection target set, that the second inspection target exists in the inspection target set; or
determining, in response to no second geographical position exists in the inspection target set, that no second inspection target exists in the inspection target set.

5. The method for detecting and positioning an inspection target according to claim 3, wherein the obtaining the target inspection sub-area comprises:
obtaining an inspection image obtained by the inspection device; and
determining an inspection map area corresponding to the inspection image as the target inspection sub-area.

6. The method for detecting and positioning an inspection target according to claim 5, wherein before the determining an inspection map area corresponding to the inspection image as the target inspection sub-area, the method comprises:
obtaining vertex image coordinates of the inspection image, the vertex image coordinates being coordinates in a pixel coordinate system;
performing coordinate transformation on the vertex image coordinates to obtain inspection position coordinates corresponding to the inspection image, the inspection position coordinates being coordinates in a world coordinate system; and
determining, in the inspection map, a sub-area formed by enclosing the inspection position coordinates as the inspection map area corresponding to the inspection image.

7. The method for detecting and positioning an inspection target according to claim 1, wherein the detecting a first inspection target and a first geographical position of the first inspection target in a target inspection sub-area of an inspection device comprises:
performing inspection target identification on the inspection image obtained by the inspection device to obtain the first inspection target and first image coordinates of the first inspection target in the inspection image; and
performing coordinate transformation on the first image coordinates to obtain first geographical position coordinates of the first inspection target, the first geographical position coordinates being coordinates in a world coordinate system.

8. The method for detecting and positioning an inspection target according to claim 7, wherein the performing inspection target identification on the inspection image obtained by the inspection device to obtain the first inspection target and first image coordinates of the first inspection target in the inspection image comprises:
performing, by means of a target identification model, inspection target identification on the inspection image obtained by the inspection device to obtain the first inspection target and the first image coordinates of the first inspection target in the inspection image.

9. The method for detecting and positioning an inspection target according to claim 7, wherein the performing coordinate transformation on the first image coordinates to obtain first geographical position coordinates of the first inspection target comprises:
obtaining a first device posture and first device position coordinates of the inspection device, the first device posture being a device posture when the inspection device obtains the inspection image, the first device position coordinates being geographical position coordinates when the inspection device obtains the inspection image, and the first device position coordinates being coordinates in the world coordinate system;
determining a target transformation matrix based on the first device posture and the first device position coordinates, the target transformation matrix being used to denote a transformation relationship between a pixel coordinate system and the world coordinate system when the inspection device obtains the inspection image; and
performing, based on the target transformation matrix, coordinate transformation on the first image coordinates to obtain the first geographical position coordinates.

10. An apparatus for detecting and positioning an inspection target, comprising:
a target detection module, configured to detect a first inspection target and a first geographical position of the first inspection target in a target inspection sub-area of an inspection device, the target inspection sub-area being a sub-area inspected by the inspection device during a process of performing an inspection task; and
a target display module, configured to display the first inspection target at the first geographical position in an inspection map.

11. The apparatus for detecting and positioning an inspection target according to claim 10, wherein the display the first inspection target at the first geographical position in an inspection map comprises:
add the first inspection target and the first geographical position to an inspection target set, the inspection target set comprising all inspection targets and geographical positions of all the inspection targets that have been detected by the inspection device during the process of performing an inspection task; and
display all the inspection targets in the inspection target set at corresponding geographical positions of all the inspection targets in the inspection map.

12. The apparatus for detecting and positioning an inspection target according to claim 10, further comprises:
obtain the target inspection sub-area; and
delete a second inspection target and a geographical position of the second inspection target from the inspection target set, the second inspection target being an inspection target in the inspection target set and located in the target inspection sub-area.

13. The apparatus for detecting and positioning an inspection target according to claim 12, further comprises:
determine whether a second geographical position in the target inspection sub-area exists in the inspection target set; and
determine, in response to the second geographical position exists in the inspection target set, that the second inspection target exists in the inspection target set; or
determine, in response to no second geographical position exists in the inspection target set, that no second inspection target exists in the inspection target set.

14. The apparatus for detecting and positioning an inspection target according to claim 12, wherein the obtain the target inspection sub-area comprises:
obtain an inspection image obtained by the inspection device; and
determine an inspection map area corresponding to the inspection image as the target inspection sub-area.

15. The apparatus for detecting and positioning an inspection target according to claim 14, further comprises:
obtain vertex image coordinates of the inspection image, the vertex image coordinates being coordinates in a pixel coordinate system;
perform coordinate transformation on the vertex image coordinates to obtain inspection position coordinates corresponding to the inspection image, the inspection position coordinates being coordinates in a world coordinate system; and
determine, in the inspection map, a sub-area formed by enclosing the inspection position coordinates as the inspection map area corresponding to the inspection image.

16. The apparatus for detecting and positioning an inspection target according to claim 10, further comprises:
perform inspection target identification on the inspection image obtained by the inspection device to obtain the first inspection target and first image coordinates of the first inspection target in the inspection image; and
perform coordinate transformation on the first image coordinates to obtain first geographical position coordinates of the first inspection target, the first geographical position coordinates being coordinates in a world coordinate system.

17. The apparatus for detecting and positioning an inspection target according to claim 16, further comprising:
perform, by means of a target identification model, inspection target identification on the inspection image obtained by the inspection device to obtain the first inspection target and the first image coordinates of the first inspection target in the inspection image.

18. The apparatus for detecting and positioning an inspection target according to claim 16, further comprises:
obtain a first device posture and first device position coordinates of the inspection device, the first device posture being a device posture when the inspection device obtains the inspection image, the first device position coordinates being geographical position coordinates when the inspection device obtains the inspection image, and the first device position coordinates being coordinates in the world coordinate system;
determine a target transformation matrix based on the first device posture and the first device position coordinates, the target transformation matrix being used to denote a transformation relationship between a pixel coordinate system and the world coordinate system when the inspection device obtains the inspection image; and
perform, based on the target transformation matrix, coordinate transformation on the first image coordinates to obtain the first geographical position coordinates.

19. A non-transitory computer readable storage medium, wherein the computer-readable storage medium stores a computer program, the computer program comprising program instructions, and when the program instructions are executed by a processor, the processor is enabled to perform the method for detecting and positioning an inspection target, comprising:
detecting a first inspection target and a first geographical position of the first inspection target in a target inspection sub-area of an inspection device, the target inspection sub-area being a sub-area inspected by the inspection device during a process of performing an inspection task; and
displaying the first inspection target at the first geographical position in an inspection map.

20. A non-transitory computer readable storage medium according to claim 1, wherein the displaying the first inspection target at the first geographical position in an inspection map comprises:
adding the first inspection target and the first geographical position to an inspection target set, the inspection target set comprising all inspection targets and geographical positions of all the inspection targets that have been detected by the inspection device during the process of performing an inspection task; and
displaying all the inspection targets in the inspection target set at corresponding geographical positions of all the inspection targets in the inspection map.
